(19) United States
(12) Patent Application Publication
(10) Pub. No.: US 2024/0278737 A1
(43) Pub. Date: Aug. 22, 2024

(54) VEHICULAR VISION SYSTEM WITH WINDSHIELD MOUNTED CAMERA

(71) Applicant: MAGNA ELECTRONICS INC., Auburn Hills, MI (US)

(72) Inventors: Ove J. Salomonsson, Farmington Hills, MI (US); Christopher L. Van Dan Elzen, Rochester, MI (US)

(21) Appl. No.: 18/653,194

(22) Filed: May 2, 2024

Related U.S. Application Data
(63) Continuation of application No. 18/328,823, filed on Jun. 5, 2023, now Pat. No. 11,975,660.
Application No. 18/328,823 is a continuation of application No. 17/822,831, filed on Aug. 29, 2022, now Pat. No. 11,667,252.
Application No. 17/822,831 is a continuation of application No. 17/305,254, filed on Jul. 2, 2021, now Pat. No. 11,427,136.
Application No. 17/305,254 is a continuation of application No. 17/247,269, filed on Dec. 7, 2020, now Pat. No. 11,052,834.
Application No. 17/247,269 is a continuation of application No. 16/948,878, filed on Oct. 5, 2020, now Pat. No. 10,857,953.
Application No. 16/948,878 is a continuation of application No. 16/806,095, filed on Mar. 2, 2020, now Pat. No. 10,793,086.
Application No. 16/806,095 is a continuation of application No. 16/449,546, filed on Jun. 24, 2019, now Pat. No. 10,576,909.
Application No. 16/449,546 is a continuation of application No. 16/117,105, filed on Aug. 30, 2018, now Pat. No. 10,328,868.
Application No. 16/117,105 is a continuation of application No. 15/878,579, filed on Jan. 24, 2018, now Pat. No. 10,065,575.
Application No. 15/878,579 is a continuation of application No. 15/494,646, filed on Apr. 24, 2017, now Pat. No. 9,878,679.
Application No. 15/494,646 is a continuation of application No. 15/180,643, filed on Jun. 13, 2016, now Pat. No. 9,630,570.
Application No. 15/180,643 is a continuation of application No. 14/112,343, filed on Oct. 17, 2013, now Pat. No. 9,380,219.
(60) Provisional application No. 61/477,315, filed on Apr. 20, 2011.

(51) Int. Cl. B60R 11/04; B60Q 1/14; B60R 1/00; B60R 1/24; B60R 11/00; G02B 5/20; G03B 11/00; H04N 23/51; H04N 23/70

(52) U.S. Cl. CPC B60R 11/04; B60Q 1/143; B60R 1/00; B60R 1/24; G02B 5/20; G03B 11/00; H04N 23/51; H04N 23/749; B60R 2011/0026; B60R 2300/00; B60R 2300/804; B60R 2300/8086; B60R 2300/8093

(57) ABSTRACT

A vehicular vision system includes a camera module configured for mounting at an in-cabin portion of a windshield of a vehicle and including a circuit board and a camera that views forward of the vehicle and through the windshield. The camera includes a CMOS imaging sensor array. A flexible coupling is provided between the camera and the circuit board. A data processor is operable to process image data captured by the CMOS imaging sensor array. Image data captured by the CMOS imaging sensor array is encoded by a data encoder chip. Captured image data captured that is encoded at the data encoder chip is carried as a data stream from the camera module to the data processor via a cable. Communication via the cable between the camera and the data processor is bidirectional. The data processor is located in the vehicle remote from the camera module.

### CROSS REFERENCE TO RELATED APPLICATIONS

The present application is a continuation of U.S. patent application Ser. No. 18/328,823, filed Jun. 5, 2023, now U.S. Pat. No. 11,975,660, which is a continuation of U.S. patent application Ser. No. 17/822,831, filed Aug. 29, 2022, now U.S. Pat. No. 11,667,252, which is a continuation of U.S. patent application Ser. No. 17/305,254, filed Jul. 2, 2021, now U.S. Pat. No. 11,427,136, which is a continuation of U.S. patent application Ser. No. 17/247,269, filed Dec. 7, 2020, now U.S. Pat. No. 11,052,834, which is a continuation of U.S. patent application Ser. No. 16/948,878, filed Oct. 5, 2020, now U.S. Pat. No. 10,857,953, which is a continuation of U.S. patent application Ser. No. 16/806,095, filed Mar. 2, 2020, now U.S. Pat. No. 10,793,086, which is a continuation of U.S. patent application Ser. No. 16/449,546, filed Jun. 24, 2019, now U.S. Pat. No. 10,576,909, which is a continuation of U.S. patent application Ser. No. 16/117,105, filed Aug. 30, 2018, now U.S. Pat. No. 10,328,868, which is a continuation of U.S. patent application Ser. No. 15/878,579, filed Jan. 24, 2018, now U.S. Pat. No. 10,065,575, which is a continuation of U.S. patent application Ser. No. 15/494,646, filed Apr. 24, 2017, now U.S. Pat. No. 9,878,679, which is a continuation of U.S. patent application Ser. No. 15/180,643, filed Jun. 13, 2016, now U.S. Pat. No. 9,630,570, which is a continuation of U.S. patent application Ser. No. 14/112,343, filed Oct. 17, 2013, now U.S. Pat. No. 9,380,219, which is a 371 national phase filing of PCT/US12/34236, filed Apr. 19, 2012, which claims the filing benefit of U.S. provisional application Ser. No. 61/477,315, filed Apr. 20, 2011, which is hereby incorporated herein by reference in its entirety.

### FIELD OF THE INVENTION

The present invention relates to imaging systems or vision systems for vehicles.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a vision system or imaging system for a vehicle that utilizes one or more cameras to capture images exterior of the vehicle, and provides the communication/data signals, including camera data or image data, that may be processed by an image processor, such as for a headlamp control or other machine vision system, or that may be displayed at a display screen that is viewable by the driver of the vehicle.

According to an aspect of the present invention, a vision system for a vehicle includes a camera or image sensor disposed at a windshield of a vehicle and having a field of view forward of the vehicle and through the windshield of the vehicle, and a processor operable to process data transmitted by the camera. The vision system or camera assembly or system includes an angular filter disposed at or near the windshield forward of the camera. The angular filter comprises a substantially transparent film that limits reflection of light through an angular range that generally corresponds to the stray light that reflects off of the vehicle (such as off of the vehicle dashboard) and would otherwise impinge the camera lens aperture.

The camera is electrically connected to circuitry established at a circuit board that is mounted generally along the windshield behind the camera, and the camera preferably is electrically connected to the circuitry via a flexible electrical connector. The flexible electrical connector flexes to allow a viewing angle of the camera to be adjusted relative to a mounting angle of the circuit board.

Therefore, the present invention provides an angular light filter that rejects or substantially rejects or attenuates reflections from the vehicle dash board into the camera. The angular filter replaces the stray light cone or shroud of a typical module or housing, allowing greater flexibility and lower mounting of the camera at the windshield.

These and other objects, advantages, purposes and features of the present invention will become apparent upon review of the following specification in conjunction with the drawings.

### BRIEF DESCRIPTION OF THE DRAWINGS

FIG. 1 is a perspective view of a camera disposed at a module that attaches at an interior surface of a vehicle windshield and that includes a stray light cone in front of the camera as part of the module or housing;

FIG. 2 is a perspective view of the camera module of FIG. 1, shown with the module mounted at a vehicle windshield with the stray light cone extending forward from the camera and along the windshield; and

FIG. 3 is a sectional view of a camera assembly or system with an angular light filter disposed along the windshield in front of the camera in accordance with the present invention.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a forward (or rearward) direction.

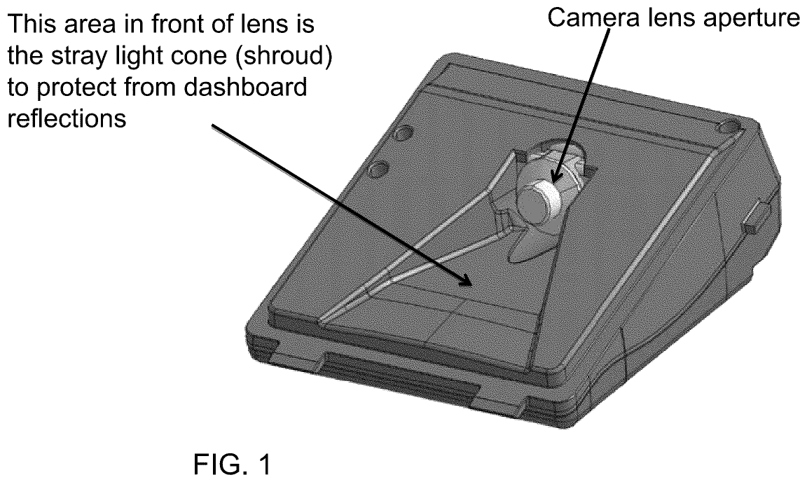

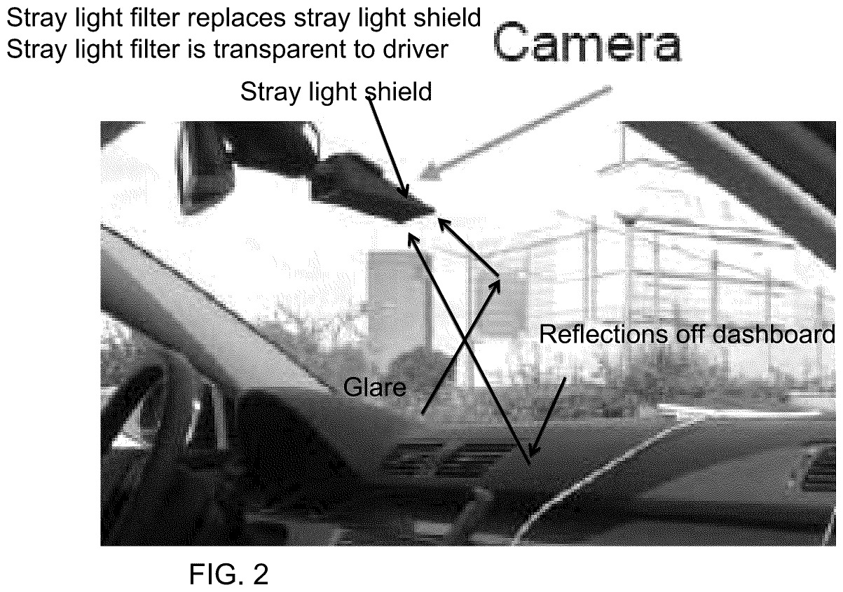

Front facing vehicular cameras include optical elements that constitute the camera. These elements are typically mounted in a vehicular camera housing, such as a windshield electronics module housing or the like, such as shown in FIGS. 1 and 2 (and such as a housing that utilizes aspects of the vision systems described in U.S. Pat. Nos. 7,526,103; 7,480,149; 7,188,963; 6,824,281; 6,341,523; 6,250,148; 6,516,664 and/or 6,968,736, which are hereby incorporated herein by reference in their entireties). As can be seen with reference to FIGS. 1 and 2, the housing may extend forward of the camera lens aperture and includes a stray light cone or shroud which serves to insulate the camera lens aperture from stray light that arises from reflections off the dashboard and/or windshield. Such housings are typically relatively bulky compared to the optical elements of the camera and thus the housing may occupy a considerable amount of windshield real estate or space. It thus may be desirable to eliminate the housing, or at least minimize the extent of the camera housing, so as to free up space on the windshield. This would not only provide better aesthetics, but also increased visibility through the windshield for the driver of the vehicle.

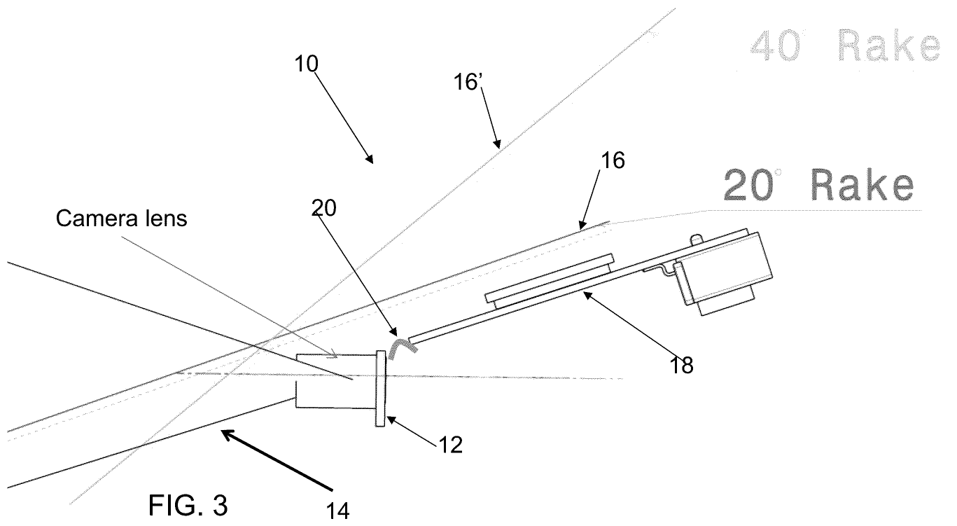

As shown in FIG. 3, the present invention proposes to eliminate the stray light cone or shroud and minimize the camera housing so that the housing only contains the optical elements of the camera and any necessary interfacing elements. At the very least, the present invention seeks to eliminate the stray light cone or shroud so that there is a minimum of the camera housing projecting forward of the camera lens aperture. Instead of a stray light cone or shroud, the camera or vision system 10 of the present invention includes a camera 12, with an angular filter 14 placed on or near the windshield 16 forward of the camera 12 and the camera lens aperture (and not part of or incorporated in a camera housing of a windshield electronics module or the like). The angular filter 14 comprises a transparent (or substantially transparent or light transmitting) or see-through film, which limits or substantially precludes reflection of light through an angular range corresponding to the stray light that would otherwise impinge the camera lens aperture.

The angular filter 14 may comprise any suitable materials. For example, a suitable film material may be found on the likes of computer notebook screens and other types of display monitors and are commercially available from the 3M Company and other suppliers. In some embodiments, the filter may be placed directly on the windshield, and in other embodiments (and such as shown in FIG. 3) the filter may be spaced apart from the windshield surface on a plane just below the camera lens aperture, in which case the filter may be mounted on a transparent substrate (not shown) or the like. Optionally, the filter may be provided in the form of anti-reflective coating on the windshield, which acts to prevent reflections from the windshield.

With the proposed structure, the designer of the camera system or vision system is afforded a great deal of design flexibility. In particular, and as can be seen with reference to FIG. 3, it will be appreciated that the printed circuit board 18 and other electronic components may be housed and disposed rearward of the camera optical elements and placed higher up on or along or near the windshield or even hidden all together under the vehicle roof liner.

Optionally, and as shown in FIG. 3, a flexible coupling 20 may also be provided between the small camera 12 and the printed circuit board 18. With such a flexible coupling (which electrically connects circuitry of the circuit board with circuitry of the camera to power and/or control the camera and to receive image data from the camera), the present invention may provide a universal or substantially universal solution to many vehicles which may all have different windshield rake angles. For example, and as can be seen with reference to FIG. 3, the flexible coupling 20 may flex to allow the camera 12 to be arranged generally horizontally when the circuit board 18 is mounted along (and generally parallel to) the windshield 16, such as, for example, along a windshield that has a rake angle of about 20 degrees, and the flexible coupling 20 may be adjusted or flexed to allow the camera 12 to be arranged generally horizontally when the circuit board 18 is mounted along a different windshield 16′, such as, for example, along a windshield that has a rake angle of about 40 degrees. The flexible electrical connector thus flexes to allow a viewing angle of the camera to be adjusted relative to a mounting angle of the circuit board, depending on the particular vehicle application of the camera system. Thus, a common camera assembly or system 10 may be provided that may readily be adapted or configured for application to vehicles with different windshield angles (with the flexible coupling or flex connection allowing for adjustment of the angular tilt or relative angles between the camera and lens axis and the circuit board), without requiring additional mounting bracketry and the like to adapt the assembly to the particular vehicle.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. provisional application Ser. No. 61/565,713, filed Dec. 1, 2011; and/or Ser. No. 61/563,965, filed Nov. 28, 2011, which are hereby incorporated herein by reference in their entireties.

As disclosed in U.S. provisional application Ser. No. 61/565,713, filed Dec. 1, 2011 (incorporated herein by reference in its entirety), the vehicle includes a display device operable to display images for viewing by a driver of the vehicle. The camera can provide almost raw image data to the display device and has a control channel for a data line (which might be any kind of data line or bus), and wherein a graphics engine runs as a routine at the display device (with, for example, the graphics engine running as a routine on a head unit of the vehicle). The camera may be part of an automotive vision system, which uses LVDS as a bidirectional control channel and an image data transfer channel and comprising an automotive vision multi camera architecture, where all cameras are controlled by one control/image data processing device, and where an image data processing device sends processed image data to the head unit or other display device and with the system processing image data captured by more than one camera and by other driver assistant system sources such as ultrasound sensors, radar sensors, infrared and visual cameras, lidar or laser sensors. The automotive vision system may use LVDS data decoders. A driver assist system and/or vision system and/or object detection system and/or alert system may operate to capture images exterior of the vehicle and process the captured image data to detect objects at or near the vehicle and in the predicted path of the vehicle, such as to assist a driver of the vehicle in maneuvering the vehicle. The object detection may utilize detection and analysis of moving vectors representative of objects detected in the field of view of the vehicle camera, in order to determine which detected objects are objects of interest to the driver of the vehicle. An image data stream from the camera to the head unit (or other end device) is realized on a data encoder chip, preferably by a Low Voltage Differential Signal (LVDS) or Ethernet interface, preferably using a mono coaxial cable and LVDS/Ethernet encoder chips (in the camera and in the head unit). The data stream can be mono-directional. Optionally, a control line may be realized by a CAN/LIN/other car bus interface or just by a single signal line/wire. Optionally, the control signal may be transferred via the data encoder chip, preferably by LVDS, so the interfaces and data stream are bi-directional.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, an array of a plurality of photosensor elements arranged in 640 columns and 480 rows (a 640×480 imaging array), with a respective lens focusing images onto respective portions of the array. The photosensor array may comprise a plurality of photosensor elements arranged in a photosensor array having rows and columns. The logic and control circuit of the imaging sensor may function in any known manner, such as in the manner described in U.S. Pat. Nos. 5,550,677; 5,877,897; 6,498,620; 5,670,935; 5,796,094 and/or 6,396,397, and/or U.S. provisional applications, Ser. No. 61/615,410, filed Mar. 26, 2012; Ser. No. 61/613,651, filed 2012; Ser. No. 61/607,229, filed Mar. 6, 2012; Ser. No. 61/605,409, filed Mar. 1, 2012; Ser. No. 61/602,878, filed Feb. 24, 2012; Ser. No. 61/602,876, filed Feb. 24, 2012; Ser. No. 61/600,205, filed Feb. 17, 2012; Ser. No. 61/588,833, filed Jan. 20, 2012; Ser. No. 61/583,381, filed Jan. 5, 2012; Ser. No. 61/579,682, filed Dec. 23, 2011; Ser. No. 61/570,017, filed Dec. 13, 2011; Ser. No. 61/568,791, filed Dec. 9, 2011; Ser. No. 61/567,446, filed Dec. 6, 2011; Ser. No. 61/559,970, filed Nov. 15, 2011; Ser. No. 61/552,167, filed Oct. 27, 2011; Ser. No. 61/540,256, filed Sep. 28, 2011; Ser. No. 61/513,745, filed Aug. 1, 2011; Ser. No. 61/511,738, filed Jul. 26, 2011; and/or Ser. No. 61/503,098, filed Jun. 30, 2011, which are all hereby incorporated herein by reference in their entireties. The system may communicate with other communication systems via any suitable means, such as by utilizing aspects of the systems described in PCT Application No. PCT/US10/038477, filed Jun. 14, 2010, and/or U.S. patent application Ser. No. 13/202,005, filed Aug. 17, 2011, now U.S. Pat. No. 9,126,525, and/or U.S. provisional applications, Ser. No. 61/567,150, filed Dec. 6, 2011; Ser. No. 61/565,713, filed Dec. 1, 2011; and/or Ser. No. 61/537,279, filed Sep. 21, 2011, which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and 6,824,281, and/or International Publication No. WO 2010/099416, published Sep. 2, 2010, and/or PCT Application No. PCT/US10/47256, filed Aug. 31, 2010, and/or U.S. patent application Ser. No. 12/508,840, filed Jul. 24, 2009, and published Jan. 28, 2010 as U.S. Pat. Publication No. US 2010-0020170; and/or U.S. provisional applications, Ser. No. 61/511,738, filed Jul. 26, 2011; and/or Ser. No. 61/503,098, filed Jun. 30, 2011, which are all hereby incorporated herein by reference in their entireties. The camera or cameras may comprise any suitable cameras or imaging sensors or camera modules, and may utilize aspects of the cameras or sensors described in U.S. patent application Ser. No. 12/091,359, filed Apr. 24, 2008; and/or Ser. No. 13/260,400, filed Sep. 26, 2011, and/or U.S. Pat. Nos. 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606 and/or 7,720,580, and/or U.S. patent application Ser. No. 10/534,632, filed May 11, 2005, now U.S. Pat. No. 7,965,336; and/or PCT Application No. PCT/US2008/076022, filed Sep. 11, 2008 and published Mar. 19, 2009 as International Publication No. WO 2009/036176, and/or PCT Application No. PCT/US2008/078700, filed Oct. 3, 2008 and published Apr. 9, 2009 as International Publication No. WO 2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149 and/or 7,526,103, which are all hereby incorporated herein by reference in their entireties, a rain sensor, such as the types disclosed in commonly assigned U.S. Pat. Nos. 6,353,392; 6,313,454; 6,320,176 and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978 and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,720,580; 7,038,577; 5,929,786 and/or 5,786,772, and/or U.S. patent application Ser. No. 11/239,980, filed Sep. 30, 2005, now U.S. Pat. No. 7,881,496, and/or U.S. provisional applications, Ser. No. 60/628,709, filed Nov. 17, 2004; Ser. No. 60/614,644, filed Sep. 30, 2004; Ser. No. 60/618,686, filed Oct. 14, 2004; Ser. No. 60/638,687, filed Dec. 23, 2004, which are hereby incorporated herein by reference in their entireties, a video device for internal cabin surveillance and/or video telephone function, such as disclosed in U.S. Pat. Nos. 5,760,962; 5,877,897; 6,690,268 and/or 7,370,983, and/or U.S. patent application Ser. No. 10/538,724, filed Jun. 13, 2005 and published Mar. 9, 2006 as U.S. Publication No. US-2006-0050018-A1, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. Nos. 7,255,451 and/or 7,480,149; and/or U.S. patent application Ser. No. 11/226,628, filed Sep. 14, 2005 and published Mar. 23, 2006 as U.S. Publication No. US-2006-0061008, and/or Ser. No. 12/578,732, filed Oct. 14, 2009 and published Apr. 22, 2010 as U.S. Publication No. US-2010-0097469, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. patent application Ser. No. 13/333,337, filed Dec. 21, 2011, now U.S. Pat. No. 9,264,672, which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252 and/or 6,642,851, and/or European patent application, published Oct. 11, 2000 under Publication No. EP 0 1043566, and/or U.S. patent application Ser. No. 11/226,628, filed Sep. 14, 2005 and published Mar. 23, 2006 as U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in PCT Application No. PCT/US2011/056295, filed Oct. 14, 2011 and published Apr. 19, 2012 as International Publication No. WO 2012/051500, which is hereby incorporated herein by reference in its entirety). Optionally, the vision system (utilizing a forward and/or rearward facing camera and other cameras disposed at the vehicle with exterior fields of view) and/or the camera or cameras as part of a vehicle vision system comprising or utilizing a plurality of cameras (such as utilizing a rearward facing camera and sidewardly facing cameras and a forwardly facing camera disposed at the vehicle), may provide a display of a top-down view or birds-eye view of the vehicle or a surround view at the vehicle, such as by utilizing aspects of the vision systems described in PCT Application No. PCT/US10/25545, filed Feb. 26, 2010 and published on Sep. 2, 2010 as International Publication No. WO 2010/099416, and/or PCT Application No. PCT/US10/47256, filed Aug. 31, 2010 and published Mar. 10, 2011 as International Publication No. WO 2011/028686, and/or PCT Application No. PCT/US11/62834, filed Dec. 1, 2011 and published Jun. 7, 2012 as International Publication No. WO 2012-075250, and/or U.S. patent application Ser. No. 13/333,337, filed Dec. 21, 2011, now U.S. Pat. No. 9,264,672, and/or U.S. provisional applications, Ser. No. 61/615,410, filed Mar. 26, 2012; Ser. No. 61/588,833, filed Jan. 20, 2012; Ser. No. 61/570,017, filed Dec. 13, 2011; Ser. No. 61/568,791, filed Dec. 9, 2011; Ser. No. 61/559,970, filed Nov. 15, 2011; Ser. No. 61/540,256, filed Sep. 28, 2011, which are hereby incorporated herein by reference in their entireties.

Optionally, the video mirror display may be disposed rearward of and behind the reflective element assembly and may comprise a display such as the types disclosed in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. patent application Ser. No. 12/091,525, filed Apr. 25, 2008, now U.S. Pat. No. 7,855,755; Ser. No. 11/226,628, filed Sep. 14, 2005 and published Mar. 23, 2006 as U.S. Publication No. US-2006-0061008; and/or Ser. No. 10/538,724, filed Jun. 13, 2005 and published Mar. 9, 2006 as U.S. Publication No. US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036 and/or 7,274,501, which are hereby incorporated herein by reference in their entireties.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742 and 6,124,886, and/or U.S. patent application Ser. No. 10/538,724, filed Jun. 13, 2005 and published Mar. 9, 2006 as U.S. Publication No. US-2006-0050018, which are hereby incorporated herein by reference in their entireties.

Changes and modifications to the specifically described embodiments may be carried out without departing from the principles of the present invention, which is intended to be limited only by the scope of the appended claims as interpreted according to the principles of patent law.

1. A vehicular vision system, said vehicular vision system comprising:
a camera module configured for mounting at an in-cabin portion of a windshield of a vehicle;
wherein said camera module comprises a camera and a circuit board;
wherein, with said camera module mounted at the in-cabin portion of the windshield, said camera views forward of the vehicle and through the windshield of the vehicle;
wherein said camera comprises a CMOS imaging sensor array and a lens;
wherein the CMOS imaging sensor array comprises a plurality of photosensor elements arranged in a photosensor array having rows and columns;
wherein said lens is accommodated in a lens barrel having a longitudinal axis;
wherein, with said camera module mounted at the in-cabin portion of the windshield, said circuit board is tilted at an acute angle relative to the longitudinal axis of said lens barrel of said camera;
wherein a flexible coupling is provided between said camera and said circuit board;
wherein said flexible coupling electrically connects said camera to circuitry of said circuit board (i) to provide power to said camera, (ii) to control said camera and (iii) to enable said circuit board to receive image data from said camera;
a data processor operable to process image data captured by the CMOS imaging sensor array of said camera;
wherein image data captured by the CMOS imaging sensor array of said camera is encoded by a data encoder chip;
wherein image data captured by the CMOS imaging sensor array of said camera that is encoded at the data encoder chip is carried as a data stream to the data processor via a cable;
wherein image data captured by the CMOS imaging sensor array of said camera that is encoded at the data encoder chip and that is carried to the data processor via the cable is processed at the data processor for (i) a vehicle headlamp control system of the vehicle, (ii) a lane departure warning system of the vehicle and (iii) a traffic sign recognition system of the vehicle;
wherein communication via the cable is bidirectional; and
wherein the data processor is located in the vehicle remote from said camera module.

2. The vehicular vision system of claim 1, wherein the vehicle is equipped with at least one radar, and wherein data captured by the at least one radar is provided to and is processed at the data processor.

3. The vehicular vision system of claim 2, wherein said camera views forward of the vehicle and through the windshield of the vehicle via a stray light shroud.

4. The vehicular vision system of claim 3, wherein the windshield of the vehicle, as mounted in the vehicle, has a rake angle of at least 20 degrees.

5. The vehicular vision system of claim 4, wherein the rake angle of the windshield of the vehicle is less than 40 degrees.

6. The vehicular vision system of claim 2, wherein processing at the data processor of image data captured by the CMOS imaging sensor array of said camera detects objects exterior of the vehicle.

7. The vehicular vision system of claim 6, wherein processing at the data processor of image data captured by the CMOS imaging sensor array of said camera to detect objects exterior of the vehicle utilizes analysis of moving vectors representative of objects viewed by said camera.

8. The vehicular vision system of claim 7, wherein, with said camera module mounted at the in-cabin portion of the windshield, the longitudinal axis of said lens barrel of said camera is at or close to horizontal.

9. The vehicular vision system of claim 2, wherein, with said camera module mounted at the in-cabin portion of the windshield, at least a portion of said circuit board is disposed at the windshield rearward of said lens of said camera.

10. The vehicular vision system of claim 1, wherein, with said camera module mounted at the in-cabin portion of the windshield, said circuit board subtends an angle relative to the in-cabin portion of the windshield that is less than an angle subtended by the longitudinal axis of said lens barrel of said camera relative to the in-cabin portion of the windshield.

11. The vehicular vision system of claim 1, wherein, with said camera module mounted at the in-cabin portion of the windshield, said circuit board subtends an angle relative to horizontal that is greater than an angle subtended by the longitudinal axis of said lens barrel of said camera relative to horizontal.

12. The vehicular vision system of claim 1, wherein said camera views forward of the vehicle and through the windshield of the vehicle via an angular filter.

13. The vehicular vision system of claim 1, wherein the data processor operable to process image data comprises image processing circuitry.

14. The vehicular vision system of claim 13, wherein the cable comprises a coaxial cable.

15. The vehicular vision system of claim 14, wherein image data captured by the CMOS imaging sensor array of said camera that is encoded at the data encoder chip is carried via the cable from said camera module utilizing Low Voltage Differential Signaling (LVDS).

16. The vehicular vision system of claim 15, wherein the data encoder chip comprises an LVDS encoder chip.

17. The vehicular vision system of claim 1, wherein the vehicle is equipped with at least one other camera, and wherein image data captured by the at least one other camera is provided to and is processed at the data processor.

18. The vehicular vision system of claim 17, wherein the at least one other camera is part of a birds-eye surround view system of the vehicle.

19. A vehicular vision system, said vehicular vision system comprising:
a camera module configured for mounting at an in-cabin portion of a windshield of a vehicle;
wherein said camera module comprises a camera and a circuit board;
wherein, with said camera module mounted at the in-cabin portion of the windshield, said camera views forward of the vehicle and through the windshield of the vehicle;
wherein said camera comprises a CMOS imaging sensor array and a lens;
wherein the CMOS imaging sensor array comprises a plurality of photosensor elements arranged in a photosensor array having rows and columns;
wherein said lens is accommodated in a lens barrel having a longitudinal axis;
wherein, with said camera module mounted at the in-cabin portion of the windshield, said circuit board is tilted at an acute angle relative to the longitudinal axis of said lens barrel of said camera;
wherein a flexible coupling is provided between said camera and said circuit board;
wherein said flexible coupling electrically connects said camera to circuitry of said circuit board (i) to provide power to said camera, (ii) to control said camera and (iii) to enable said circuit board to receive image data from said camera;
a data processor operable to process image data captured by the CMOS imaging sensor array of said camera;
wherein image data captured by the CMOS imaging sensor array of said camera is encoded by a data encoder chip;
wherein image data captured by the CMOS imaging sensor array of said camera that is encoded at the data encoder chip is carried as a data stream to the data processor via a coaxial cable;
wherein the vehicle is equipped with at least one other camera, and wherein image data captured by the at least one other camera is provided to and is processed at the data processor;
wherein image data captured by the CMOS imaging sensor array of said camera that is encoded at the data encoder chip and that is carried to the data processor via the coaxial cable is processed at the data processor for (i) a vehicle headlamp control system of the vehicle, (ii) a lane departure warning system of the vehicle and (iii) a traffic sign recognition system of the vehicle;
wherein communication via the coaxial cable is bidirectional; and
wherein the data processor is located in the vehicle remote from said camera module.

20. The vehicular vision system of claim 19, wherein the vehicle is equipped with at least one radar, and wherein data captured by the at least one radar is provided to and is processed at the data processor.

21. The vehicular vision system of claim 20, wherein said camera views forward of the vehicle and through the windshield of the vehicle via a stray light shroud.

22. The vehicular vision system of claim 21, wherein processing at the data processor of image data captured by the CMOS imaging sensor array of said camera detects objects exterior of the vehicle.

23. The vehicular vision system of claim 22, wherein processing at the data processor of image data captured by the CMOS imaging sensor array of said camera to detect objects exterior of the vehicle utilizes analysis of moving vectors representative of objects viewed by said camera.

24. The vehicular vision system of claim 21, wherein, with said camera module mounted at the in-cabin portion of the windshield, the longitudinal axis of said lens barrel of said camera is at or close to horizontal.

25. The vehicular vision system of claim 21, wherein, with said camera module mounted at the in-cabin portion of the windshield, at least a portion of said circuit board is disposed at the windshield rearward of said lens of said camera.

26. The vehicular vision system of claim 19, wherein the windshield of the vehicle, as mounted in the vehicle, has a rake angle of at least 20 degrees.

27. The vehicular vision system of claim 26, wherein the rake angle of the windshield of the vehicle is less than 40 degrees.

28. The vehicular vision system of claim 19, wherein, with said camera module mounted at the in-cabin portion of the windshield, said circuit board subtends an angle relative to the in-cabin portion of the windshield that is less than an angle subtended by the longitudinal axis of said lens barrel of said camera relative to the in-cabin portion of the windshield.

29. The vehicular vision system of claim 19, wherein, with said camera module mounted at the in-cabin portion of the windshield, said circuit board subtends an angle relative to horizontal that is greater than an angle subtended by the longitudinal axis of said lens barrel of said camera relative to horizontal.

30. The vehicular vision system of claim 19, wherein the data processor operable to process image data comprises image processing circuitry.

31. The vehicular vision system of claim 19, wherein image data captured by the CMOS imaging sensor array of said camera that is encoded at the data encoder chip is carried via the coaxial cable from said camera module utilizing Low Voltage Differential Signaling (LVDS).

32. The vehicular vision system of claim 31, wherein the data encoder chip comprises an LVDS encoder chip.

33. The vehicular vision system of claim 32, wherein the at least one other camera is part of a birds-eye surround view system of the vehicle.

34. A vehicular vision system, said vehicular vision system comprising:
a camera module configured for mounting at an in-cabin portion of a windshield of a vehicle;
wherein said camera module comprises a camera and a circuit board;
wherein, with said camera module mounted at the in-cabin portion of the windshield, said camera views forward of the vehicle and through the windshield of the vehicle;
wherein said camera views forward of the vehicle and through the windshield of the vehicle via a stray light shroud;
wherein said camera comprises a CMOS imaging sensor array and a lens;
wherein the CMOS imaging sensor array comprises a plurality of photosensor elements arranged in a photosensor array having rows and columns;
wherein said lens is accommodated in a lens barrel having a longitudinal axis;
wherein, with said camera module mounted at the in-cabin portion of the windshield, said circuit board is tilted at an acute angle relative to the longitudinal axis of said lens barrel of said camera;
wherein a flexible coupling is provided between said camera and said circuit board;
wherein said flexible coupling electrically connects said camera to circuitry of said circuit board (i) to provide power to said camera, (ii) to control said camera and (iii) to enable said circuit board to receive image data from said camera;
a data processor operable to process image data captured by the CMOS imaging sensor array of said camera;
wherein image data captured by the CMOS imaging sensor array of said camera is encoded by a data encoder chip;
wherein image data captured by the CMOS imaging sensor array of said camera that is encoded at the data encoder chip is carried as a data stream to the data processor via a coaxial cable;
wherein processing at the data processor of image data captured by the CMOS imaging sensor array of said camera detects objects exterior of the vehicle;
wherein the vehicle is equipped with at least one other camera, and wherein image data captured by the at least one other camera is provided to and is processed at the data processor;
wherein the vehicle is equipped with at least one radar, and wherein data captured by the at least one radar is provided to and is processed at the data processor;
wherein image data captured by the CMOS imaging sensor array of said camera that is encoded at the data encoder chip and that is carried to the data processor via the coaxial cable is processed at the data processor for (i) a vehicle headlamp control system of the vehicle, (ii) a lane departure warning system of the vehicle and (iii) a traffic sign recognition system of the vehicle;
wherein communication via the coaxial cable is bidirectional; and
wherein the data processor is located in the vehicle remote from said camera module.

35. The vehicular vision system of claim 34, wherein image data captured by the CMOS imaging sensor array of said camera that is encoded at the data encoder chip is carried via the coaxial cable from said camera module utilizing Low Voltage Differential Signaling (LVDS).

36. The vehicular vision system of claim 35, wherein the windshield of the vehicle, as mounted in the vehicle, has a rake angle of at least 20 degrees, and wherein the rake angle of the windshield of the vehicle is less than 40 degrees.

37. The vehicular vision system of claim 34, wherein processing at the data processor of image data captured by the CMOS imaging sensor array of said camera to detect objects exterior of the vehicle utilizes analysis of moving vectors representative of objects viewed by said camera.

38. The vehicular vision system of claim 37, wherein, with said camera module mounted at the in-cabin portion of the windshield, the longitudinal axis of said lens barrel of said camera is at or close to horizontal.

39. The vehicular vision system of claim 34, wherein, with said camera module mounted at the in-cabin portion of the windshield, said circuit board subtends an angle relative to the in-cabin portion of the windshield that is less than an angle subtended by the longitudinal axis of said lens barrel of said camera relative to the in-cabin portion of the windshield.

40. The vehicular vision system of claim 34, wherein, with said camera module mounted at the in-cabin portion of the windshield, said circuit board subtends an angle relative to horizontal that is greater than an angle subtended by the longitudinal axis of said lens barrel of said camera relative to horizontal.

41. The vehicular vision system of claim 34, wherein, with said camera module mounted at the in-cabin portion of the windshield, at least a portion of said circuit board is disposed at the windshield rearward of said lens of said camera.

42. The vehicular vision system of claim 41, wherein the data encoder chip comprises a Low Voltage Differential Signaling (LVDS) encoder chip.

43. The vehicular vision system of claim 42, wherein the at least one other camera is part of a birds-eye surround view system of the vehicle.
